(19) United States
(12) Patent Application Publication
(10) Pub. No.: US 2022/0081338 A1
(43) Pub. Date: Mar. 17, 2022

(54) SYSTEMS AND DEVICES FOR ELIMINATING FILTER AIR LOCKS

(71) Applicant: ZERO TECHNOLOGIES, LLC, Trevose, PA (US)

(72) Inventor: Robert PETNER, Trevose, PA (US)

(21) Appl. No.: 17/125,226

(22) Filed: Dec. 17, 2020

Related U.S. Application Data
(60) Provisional application No. 63/078,408, filed on Sep. 15, 2020.

(51) Int. Cl. C02F 9/00; C02F 1/28; C02F 1/66; C02F 1/44

(52) U.S. Cl. CPC C02F 9/005; C02F 1/283; C02F 1/66; C02F 2307/02; C02F 2201/006; C02F 2201/004; C02F 2307/04; C02F 1/444

(57) ABSTRACT

The claimed invention relates to systems, devices, and methods of using the devices for eliminating air locks by using a filter cartridge with a truncated cone shaped lid that allows air to naturally flow to the highest point of the filter cartridge. The lid including a hole for releasing air that can slow or stop the filtration process. The filter cartridge further including a foam spacer to prevent filter media from escaping the filter cartridge.

### TECHNICAL FIELD

This technology relates to systems, devices, and methods of use of the devices to control the flow and velocity of fluids through a filter chamber. More particularly, the technology relates to systems and devices of eliminating air locks in filters when filtering fluids.

### BACKGROUND

Water filtration systems can include pour-through pitcher systems, countertop systems, and filtration cartridge systems. Pour-through pitcher systems can include an upper reservoir for receiving unfiltered water, a lower reservoir for receiving and storing filtered water, and a filtration cartridge with an inlet at its top and an outlet at its bottom, through which water flows from the upper reservoir, is filtered, and travels to the lower reservoir.

Countertop or standalone systems can include a larger filtered water tank with a spigot for dispensing filtered water into a glass or other container. Pitcher and countertop systems use gravity to move the unfiltered water in the top reservoir through a water filter and filtration cartridge and into the lower reservoir where the filtered water is stored until it is used.

Water filtration cartridges used in gravity flow systems often include a sieve system and a housing. The housing is filled with filter media, and the sieve system is sealed into the cavity of the housing. The filter media is usually granular, such as activated carbon.

A problem associated with using granular filter media in gravity flow cartridges is that air gets trapped in-between the particles of the filter media and in the headspace of the cartridge housing. Air can enter and become trapped in the cavities of the water flow path anytime the filter is not in use. When the filter is again used to filter the liquid, the heavier liquid traps the lighter air in the cavities of the filter, especially close to the underside of the filter media. The “headspace” area (a.k.a. “ullage”) is the enclosed space of the cartridge above the fill line of the filter media where the liquid first contacts the filter media. The gaseous constituents in the enclosed space of the filter media provide a back pressure and a loss of filtration surface area. Both “air lock” effects contribute to the reduction in the flow rate of the liquid through the filter.

### SUMMARY

The devices and systems of the invention provide improvements in filter performance by preventing clogging due to air-locks. The air-locks can be created in the filters when air is drawn into the top of the filters as the filters drain. The air-locks can occur when a container, such as a water pitcher, water container, or a filter cartridge, for example, is emptied, and the water level in the container is no longer in contact with the entire filter media. Air-locks can also occur when gaps are created in the filter elements. When water is poured into the filter, air can become trapped and create air-locks in the filter elements. The air lock provides a back pressure and a loss of filtration surface area, both of which reduce the flow rate of the liquids through the filter. The lid and associated filtration devices of the invention eliminate air-locks and clogging of the filter elements by routing air bubbles up and away from the filter media. Improved filter efficiency also is created by eliminating shifting of the filter media layers, as this provides a more uniform usage of the filter media.

The water filtration cartridges of the invention eliminate air locks and resulting clogging by providing an air release pathway. The water filters and filtration cartridges of the invention remove a broad range of contaminants in water as it is gravity-fed or pressure-fed through the filter cartridges. The water filtration cartridges of the invention include filters that separate or remove organic, inorganic, radiological, and microbiological contaminants from unfiltered water.

By eliminating air-locks from the filtration process, the invention provides a controlled flow rate of filtered water out of the filtration cartridge. For example, by eliminating air-locks from the water filters, with a water head of 75mm, a flow rate of water of 180-200 ml/min can be achieved. The water head describes an amount of unfiltered water held in a water reservoir, above the filter cartridge, of a filtration device such as a pitcher. One example filtration cartridge can include a micron filter, a filter media, a spacer, an air hole, a retainer, and a mesh screen.

Different geometries and material properties of the filtration cartridge can be employed depending upon the particular application in which the filtration cartridge will be used. For example, one embodiment of the filtration cartridge includes wider water inlets for larger water pitchers. In other embodiments, the filter cartridge water inlet is narrower for smaller personalized uses such as in mugs or cups. Further uses may include slightly flexible sidewalls for hydration pack bladders to allow a general flattening during storage.

The filter media of the water filter cartridge can include a mixed media or a number of layers of media. For example, the filter media can include an organic element and oxidation reduction filter layer, such as a carbon layer for removing chlorine and/or organic contaminants from the unfiltered water. The filter media can also include a mold and mildew prevention layer, such as redox alloy layer that neutralizes pH in the water.

Additionally, the filter media can include a separator or a screen configured to evenly distribute water across the surface area of the filter media to eliminate channeling within the filter media. The filter media can also include an inorganic element filter layer, such as an ion exchange layer for removing inorganic and/or radiological contaminants in the water. The ion exchange layer can include a mixed bed of cationic and anionic resins. Likewise, the ion exchange layer can include a water softener.

The water filter cartridge can be configured to provide a flow rate of filtered water of 180-200 ml/min for a water head layer of 75 mm.

One example embodiment includes a water filter where the water (or other liquid) runs along the longitudinal axis of the filter from a water inlet proximate to a first end of the water filter to a water outlet proximate to another end of the water filter. The water filter is a gravity-fed filter. Some embodiments include a water filter that also includes a food safe foam that is configured to prevent filter media spillage out of the filter and to provide even water flow at the filter layer.

One example of the invention includes a method of using a lid to eliminate air locks in a water retention filter cartridge. The method of use includes treating unfiltered water to remove organic, inorganic, and/or radiological contaminants from the unfiltered water using a water filter cartridge of the invention to produce potable water suitable for human consumption. The methods include passing untreated water through the water filter cartridge to produce potable water suitable for human consumption while eliminating air locks in the water retention filter cartridge. As outlined above, filtered water passes through a filter media and exits the water filter cartridge from the water outlet. Once the water passes through the filter cartridge and exits from the water outlet, the potable water is collected.

In passing untreated water through the water filter cartridge, a variety of contaminants and impurities are removed. For example, the method of using the filter cartridge includes removing chlorine and/or organic contaminants from the unfiltered water with a carbon layer in the filtration medium, neutralizing pH in the water with a redox alloy layer, removing inorganic and/or radiological contaminants in the water with an ion exchange layer, and eliminating discharge of the filtration medium into the output water and filtering out elements larger than one micron with a micron filter layer.

A method of using a lid to eliminate air locks in the water retention filter cartridge and treating unfiltered water can also include softening the water with a water softener in the filter media, such as in the ion exchange layer, for example.

The water filters of the invention can be integrated into containers that house and store filtered water to form air lock eliminating water treatment apparatuses. These water containers can be in fluid communication with the water filter cartridge to receive and collect the filtered water from the water outlet on the filter. The filter removes organic, inorganic, and radiological contaminants from the unfiltered water to produce potable water. The filtered, potable water can be stored in the water container for future use. Example water containers that can be integrated with the water filters of the invention include pitchers, travel bottles, sports bottles, water coolers, water jugs, and water bottles.

### BRIEF DESCRIPTION OF THE DRAWINGS

FIG. 1 shows a perspective side view of one example embodiment of a filter cartridge in accordance with the invention;

FIG. 2 shows a front view of a filter cartridge in accordance with the invention;

FIG. 3A shows a cross-sectional side view from section C-C of one example embodiment of a filter cartridge of FIG. 2 with the upper cover taken off;

FIG. 3B is an enlarged partial view of an example filter cartridge in accordance with the invention as indicated by A in FIG. 3A;

FIG. 4 shows a top view of one example embodiment of a filter cartridge in accordance with the invention;

FIG. 5 shows a bottom view of one example embodiment of a filter cartridge in accordance with the invention;

FIG. 6 shows a top view of the interior of one example embodiment of a filter cartridge in accordance with the invention without filter media;

FIG. 7 shows a top view of a lower retainer in accordance with the invention with the micron filter removed;

FIG. 8 shows a bottom perspective view of one example embodiment of a filter cartridge in accordance with the invention;

FIGS. 9A and 9B show a front perspective exploded view and side exploded view, respectively, of one example embodiment of a filter cartridge in accordance with the invention;

FIG. 10 shows a front perspective view of another example embodiment of a filter cartridge in accordance with the invention with a lid removed;

FIGS. 11A-C show a perspective view, front view, and top view, respectively, of one example embodiment of a filter cartridge in accordance with the invention with an upper cover; and

FIG. 12 shows a number of example water containers and integrated water table retention filters in accordance with the invention.

### DETAILED DESCRIPTION

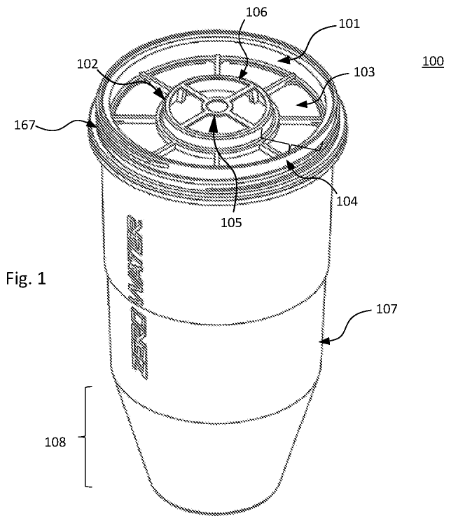

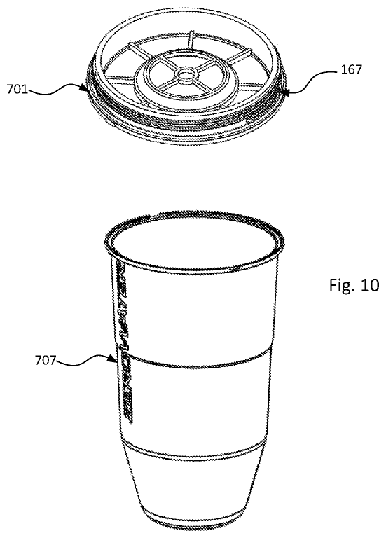

With the example embodiments shown in FIGS. 1-11C, the invention eliminates air locks in filter cartridge 100. As unfiltered water is added to a reservoir of a filter device using the filter cartridge 100, the water is directed with the force of gravity and water weight into the filter cartridge 100 and through the filter media. The filtered water exits the filter cartridge 100 and can be transferred, stored, consumed, and the like. As additional unfiltered water is added to the reservoir, the water's weight and gravity feed the unfiltered water through the filter cartridge 100. Any air remaining in the filter cartridge 100 is displaced to the top of the filter cartridge 100 and out the through-hole 105 of lid 101. In this fashion, the filter system of the invention eliminates air locks that have previously contributed to poor filtration and poor filter performance and provides a controlled flow rate of filtered water from the filtration cartridge.

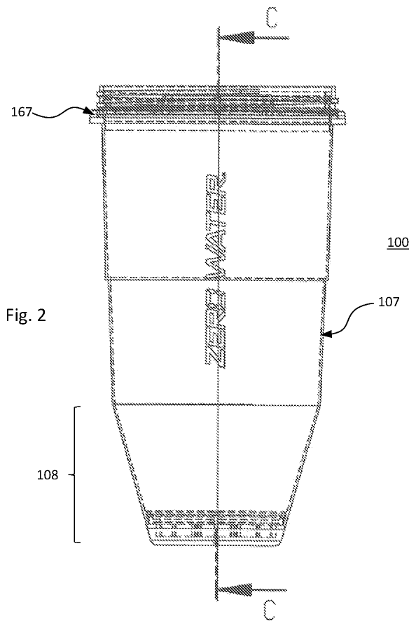

A number of example embodiments in accordance with the invention can be used to provide liquid filtration while eliminating air-locks and clogging. One example filter cartridge 100 is shown in FIG. 1. Filter cartridge 100 is also shown in front view, cross-sectional side view, top view, bottom view, bottom perspective view, and front perspective and side exploded views, respectively, in FIGS. 2, 3A, 4, 5, 8, 9A, and 9B. In the example embodiment of the invention shown in FIG. 1 the liquid (e.g., water) enters the filter cartridge 100 from the lid 101 that covers the top of housing 107. The lid 101 and housing 107 define the filter cavity that contains the filter media. Water enters the filter cartridge 100 from the lid 101, which includes a first filter screen 103 defined by radially extending supports that are connecting rods 155 and a through-hole 105. Specifically, unfiltered water enters the filter cartridge 100 through the first filter screen 103 of the lid 101.

The through-hole 105 is positioned proximate to a central axis of the filter cartridge 100. In some embodiments, the through-hole 105 is positioned at the central axis. In other embodiments, the through-hole 105 is positioned near or proximate to the central axis to position the through-hole 105 near equidistant from the opposite edges of the upper planar portion 106. The lid 101 includes a plurality of planar levels with at least one planar level proximate to the central axis and a top of the lid 101. In some embodiments, the through-hole 105 is at the very top of the lid 101 to prevent excess water from flowing into the through-hole 105 and displace air in the filter cartridge 100 to escape from the very top of the filter cartridge 100. In some embodiments, the through-hole 105 is proximate to the top of the lid 101 to displace air to a position as close to the very top of the lid 101 as possible to allow the natural air displacement to occur.

The upper planar portion 106 proximate to the top of the lid 101 is a protruding portion 102 that is in a truncated conical shaped structure extending from the lower planar level 104. In some embodiments, the upper planar portion 106 is concentric to the through-hole 105 at the central axis. The through-hole 105 is further positioned near a topmost point of the lid 101 and subsequently the filter cartridge 100. Therefore, air locked in the filter cartridge 100 exits the filter media and the cartridge 100 via the through-hole 105. The water enters from the top of the filter cartridge 100 through lid 101 and then passes through filter media 115 contained by the housing 107 to filter impurities in the water resulting potable water. In some embodiments, the upper planar portion 106 is off-center from the central axis, thus, the through-hole 106 is also off-center from the central axis. In some embodiments, the through-hole 106 may be centered on the off-center upper planar portion 106. In other embodiments, the through-hole 106 may be off-center from the upper planar portion 106 as well.

Housing

As shown in the FIGS., filter cartridge 100 can be manufactured as polypropylene outer cases within which the filter media are housed. Though the discussion below and the exemplary FIGS. refer to certain filter media for the exemplary embodiments, any filter media (media known for purification and treatment of water) or combinations of filter media known in the art can be used in accordance with the invention.

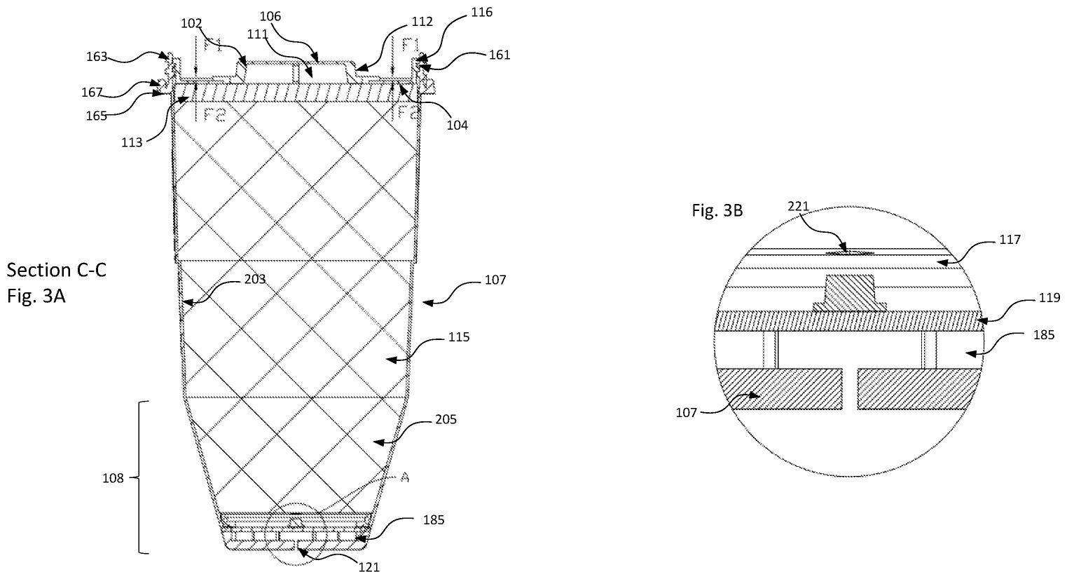

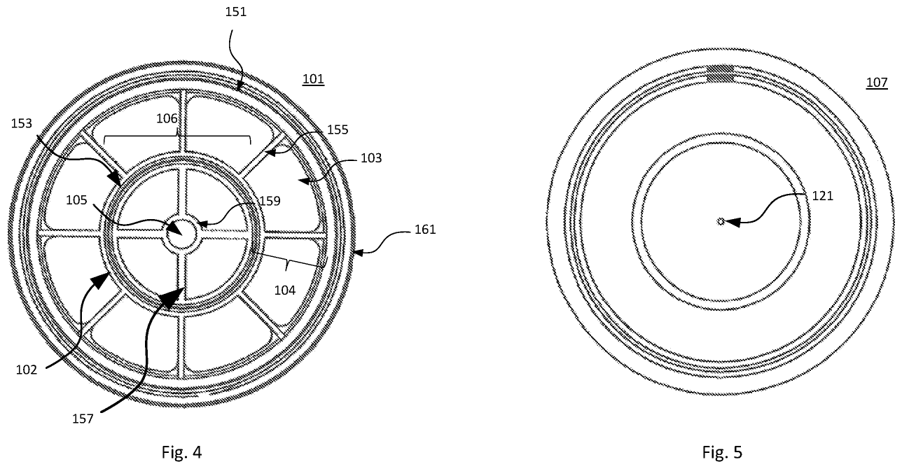

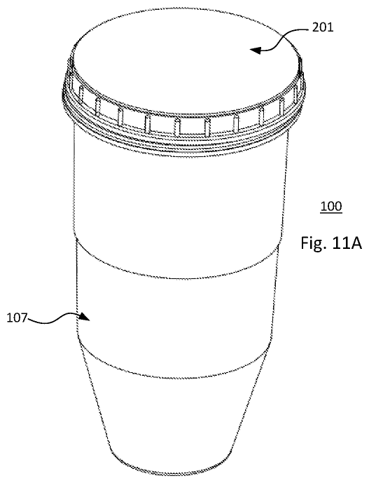

The example filter cartridge 100 of the invention shown in the FIGS. is designed and manufactured with a housing 107 defined by side walls (more clearly shown in FIG. 2) that direct the water through the filter cartridge 100, a top lid 101 with a mesh screen for unfiltered water inlet, and lower micron filter 119 for filtered water outlet 121. As shown in FIG. 3A, the housing 107 has an elongated body shape formed with a cavity 205. The cavity 205 is filled with filter media 115 to remove impurities in the water. The housing 107 includes a large opening 204 (See FIG. 9A) near the top where the lid 101 is seated, and an outlet 121 from which fluids exit the filter cartridge 100. Both the outlet 121 and the opening 204 are in fluid communication with the cavity 205.

The unfiltered water enters through the opening 204, is filtered into purified water by filter media 115 in the filter cartridge 100 (or assembly), and is discharged from the outlet 121. The filter cartridge 100 includes a lid 101 disposed at the opening 204.

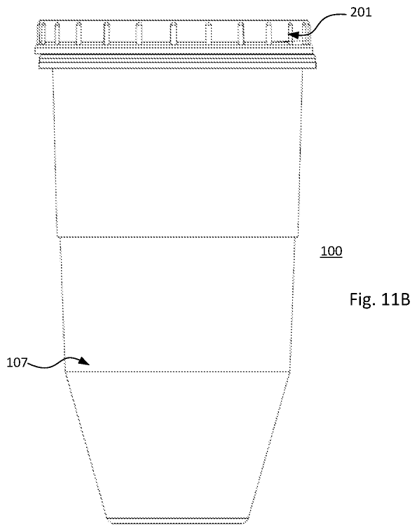

The housing 107 includes an annular seal 167 that is an integrated O-ring, as shown in FIGS. 1-3A, to seal the filter cartridge 100 to a filter device such as a pitcher. The annular seal 167 reduces the number of parts of the filter cartridge 100 and prevents misplacement which would impede filter performance. In one embodiment, as shown in FIG. 10, the annular seal 167 is incorporated into the lid 701. The annular seal 167 incorporated lid 701 is then welded to the housing 707 to provide a fluid-tight seal and prevent removal of the lid 701 from the housing 707. This embodiment also integrates all the key external parts of the filter cartridge into a single part and allows for welding along a non-critical part. Further, limiting reliance upon use of threaded attachment of the lid to the housing prevents accidental deformation of the housing 707 by the threading.

As shown in FIG. 3A, the housing 107 includes a narrower outlet 121 and wider water inlet portion as indicated by the narrowing portion 108, to direct trapped air to the top (water inlet) and direct water to the bottom (water outlet) of the filter cartridge 100. At least a portion of the housing 107 includes a truncated conical shape shown by narrowing portion 108. The lid 101 is integrated into the housing 107 by welding. The filter cartridge 100 includes an integrated O-ring providing an airtight seal between the filter and threaded component of a filter device such as a water pitcher to direct unfiltered water from a reservoir of the filter device to the first filter screen 103 of the filter cartridge 100.

Lid

The filter cartridge 100 is further detailed, as shown in FIGS. 1-10. A lid 101 is provided at the top of the filter cartridge 100. The lid 101 is designed and manufactured to evenly distribute the water across the surface area of the filter layers. The lid 101 may be integrated into the housing 107 through either force fit or welding. Welded mating is preferred to provide more consistent performance. Because the lid 101 is a separate component of housing 107, a manufacturer may use the lid of filter cartridges of different geometries as long as the mating of the lid 101 and the filter cartridges of different geometries provides a fluid-tight seal.

As shown in FIG. 1, lid 101 includes skeletal structures holding mesh and defining a lower planar portion 104 and a protruding portion 102. The protruding portion 102 protrudes upward from the lower planar portion 104, and the protruding portion 102 is provided with a through-hole 105. The protruding portion 102 is arranged in the middle of the lid 101, the protruding portion 102 comprises an upper planar portion 106 in parallel with the lower planar portion 104, and the through-hole 105 penetrates through the upper planar portion 106. The lower planar portion 104 is concentric with the upper planar portion 106. By arranging a protruding surface parallel to the lower planar portion 104, the lid 101 has a stepped shape.

As shown in FIG. 3A, lid 101 can prevent the filter media 115 from overflowing and provide preliminary filtering before the unfiltered water enters the filter media 115. During the filtration process, the unfiltered water passing through the lower planar portion 104 has gravity F1, and at the same time, the lid 101 applies a surface tension F2 opposite to the gravity F1 to the unfiltered water at the lower planar portion 104. The surface tension F2 also accounts for air bubbles that may temporarily be trapped in the filter screen 103 before exiting the through-hole 105. When F1 is greater than F2, the unfiltered water can pass through the lower planar portion 104 and be subsequently filtered by the filter media 115.

However, when F1 and F2 may balance each other, the unfiltered water cannot enter the filter media 115 through the lower planar portion 104. However, since through-hole 105 is located on the protruding portion 102, when F1 and F2 are balanced, the unfiltered water will backup to the upper planar portion 106. This backup allows unfiltered water to directly and smoothly, without air pockets effecting the flow, enter the filter media 115 from the upper planar portion 106 by bypassing the lower planar portion 104. In addition, the air bubbles or air pockets formed in the filter media 115 can be discharged through the through-hole 105 during the filtering process, thereby preventing the air bubbles or air pockets from stopping the unfiltered water from entering the filter media 115. The air bubbles being displaced and discharged through the through-hole 105 will result in F2 lowering to the point of normal fluid flow through lower planar portion 104 again. The distance between the protruding surface 102 and the lower planar portion 104 is fixed, so the distance can be set more accurately to ensure that the balance between forces F1 and F2 can be overcome when the unfiltered water enters the filter media 115.

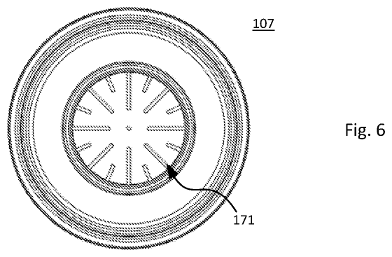

As shown in FIG. 4, lid 101 includes one to ten radial connecting rods 155, as shown in FIG. 4, to provide structural support that prevents the first filter screen 103 from collapsing from the weight of the unfiltered water entering the filter cartridge 100. The first filter screen 103 has pore sizes of between 200 to 270 microns. The lid 101 includes, near its center point and at the topmost height of the lid 101, a through-hole 105 for release of air. The through-hole 105 has at least a cross-sectional area of 0.012 square inches and has a cross-sectional area of preferably at least 0.283 square inches. The through-hole 105 provides an open cross-sectional area to release air trapped in the filter cartridge 100.

As shown in FIG. 3A, lid 101 may include a protruding portion 102 that extends toward a topmost centered portion of the lid 101. The protruding portion 102, in combination with a spacer 113, defines a cavity toward which any air trapped in the filter cartridge 100 is directed. The lid 101 may be shaped based on the cross-sectional shape of the filter cartridge 100. Thus, in the example embodiment shown in FIGS. 1, 4, and 6A, the lid 101 is shown with a protruding portion 102 that is shaped like a dome or a truncated cone. The protruding portion 102 is concentric with the lower planar portion 104 of the lid 101. The radial connecting rods 155 extend through the lower planar portion 104 toward the sidewalls of the protruding structure 112 of the protruding portion 102, and also extend through the upper planar portion 106 from the through-hole 105 to the sidewalls of the protruding structure 112 of the protruding portion 102 to provide structural support to the first filter screen 103. This dome shaped lid example includes angular or curved sidewalls of the protruding structure 112 extending from a lower planar portion 104 toward the topmost centered portion of the lid 101. In embodiments of the filter cartridge 100 with a cubical shape, for example, the protruding portion 102 may include a truncated pyramid shape extending from a lower planar portion.

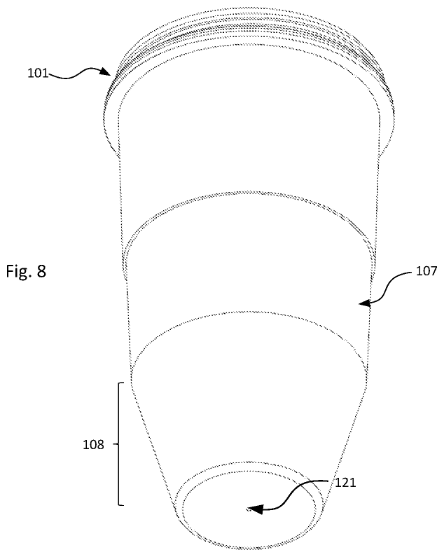

As shown in FIG. 4, the lid 101 includes radial connecting rods 155 and first filter screen 103 in an evenly distributed pattern to allow consistent and even distribution of unfiltered water into the filter cartridge 100. The radial connecting rods 155 may include radial supports to provide strength to the first filter screen 103 and to prevent deformation of the first filter screen 103 due to the forces of gravity and the weight of the unfiltered water. The lid 101 may include between one and ten radial structures. As shown in FIG. 6, in some embodiments, a radial supporting structure is formed comprising a plurality of radial connecting rods 155 uniformly arranged along the outer circumference of the protruding structure 112. A water flow path directing the flow of water through the lid 101 into the filter cartridge 100. The water flow path can be formed through lower planar portion 104 between the plurality of first connecting rods 155, thus reducing the structural materials of lid 101 while providing a water flow path.

Referring to FIGS. 3A and 4, in some embodiments, the protruding structure 112 includes a connecting portion 153 connected to the radial connecting rod 155, a support ring 159 is provided in the middle of the connecting portion 153, and a through-hole 105 penetrates the support ring 159 is provided, and the support ring 159 is connected to the connecting portion 153 through the second connecting rod 157. Such a structure arrangement allows the protruding structure 112 to have more water flow paths directing the flow of water through the lid 101.

In some embodiments, lid 101 comprises a first peripheral portion 151 at an outer circumference of the lid 101. Concentric to, and interior to, the first peripheral portion 151 is a lower planar portion 104. The protruding structure 112 could be of any shape protruding upward, for example, in FIG. 1 and FIG. 3A the protruding structure 112 is of dome shape. Connecting portion 153 is substantially co-planar with lower planar portion 104. Protruding structure 112 is also concentric to the center of the first peripheral portion 151. Protruding structure 112 extends/protrudes vertically above the lower planar portion 104 and forms upper planar portion 106. In some embodiments, second connecting rods 157 extend from the protruding structure 112 radially and are substantially co-planar with upper planar portion 106. The second connecting rods 157 connect protruding structure 112 to a support ring 159 Support ring 159 provides through-hole 105. The radial connecting rods 155 support the lower planar portion 104 formed by the first peripheral portion 151 and the connecting portion 153. The first filter screen 103 can be suspended by the radial connecting rods 155 corresponding to the shape of the first filter screen 103. Additionally, it is understandable that the first filter screen 103 can be integrally formed on the lid 101 by injection molding, or the first filter screen 103 can be connected to the lid 101 by ultrasonic welding.

As shown in FIG. 3A, lid 101 includes two or more planar portions 106 and 104 which provide an upper and lower plane, respectively, of screens and water flow paths that drive trapped air toward the upper planar portion 106 of the lid 101. By providing an upward space to displace trapped air for release, due to the buoyancy of the air, the air is naturally driven toward the through-hole 105. Additionally, the air is driven toward the through-hole due to water flow through the screened portions of the lid 101. The upper planar portion 106 includes through-hole 105 that allows air trapped in the filter cartridge 100 to escape. In the embodiment shown, the through-hole 105 is a circular opening, however such a hole may be any shape with a cross-sectional area of at least 0.012 square inches and has a cross-sectional area of preferably at least 0.283 square inches. The through-hole 105 is at least 0.125 inches in diameter and preferably larger in diameter. The through-hole 105 is configured to be large enough to prevent trapping of air in the filter cartridge 100 and small enough to limit access by larger impurities in the unfiltered water to the filter cartridge 100.

The upper planar portion 106 of the lid 101 has a domed or truncated conical shape with walls that extend upward from the lower planar portion 104. The upper planar portion 106 walls drive trapped air toward the center/highest point of the upper planar portion 106, from the lower planar portion 104. The walls may be more angled for greater arc toward the highest point of the upper planar portion 106. The upper planar portion 106 is approximately 0.2 inches above the lower planar portion 104 to provide an open cavity 111 between the upper planar portion 106 and the spacer 113 is a foam allowing trapped air to escape.

The mesh screen is integrated into the lid and supported by the radial structures. The first filter screen 103 that is a mesh screen may be chosen from food/medical grade materials such as woven stainless steel, polyester (PET), nylon, polypropylene, polyether ether ketone (PEEK), or nonwoven types of the same materials. The first filter screen 103 is chosen from a material capable of integration into the lid 101 structures for consumption of filtered water, strong enough to prevent breaking of the screen due to forces of gravity and the weight of the unfiltered water, and having a pore size of between 200 to 270 microns. The pore size is configured to be smaller than the filter media 115 contained in the filter cartridge 100. In some embodiments, the first filter screen 103 is a polypropylene screen. The first filter screen 103 is preferably a woven screen greater strength and the micron filter 119 is preferably a nonwoven screen to allow higher flow rate and permittivity. However, both the first filter screen 103 and micron filter 119 may be made of the same material type (e.g., nonwoven or woven) and/or material as well. The first filter screen 103 may include a plurality of mesh screens separately integrated into the lid or a single-piece mesh screen integrated into the lid.

As shown in FIG. 3A, in some embodiments, a spacer 113 is further included, and the spacer 113 is connected to the bottom of the lid 101 by ultrasonic welding. The spacer 113 can filter the water flow before the water flow enters the filter media 115. The spacer 113 will not float up and down or move if the spacer 113 is connected with ultrasonic welding. The spacer 113 is ultrasonically welded to the lid 101 to prevent the mixed media from escaping the filter cartridge 100. The spacer 113 is a food safe foam or other material configured to both prevent escape of filter media from the filter cartridge 100, evenly distribute unfiltered water through the filter cartridge 100, and permit air to pass into the cavity 111 for release through-hole 105.

As further shown in FIGS. 3A and 4, in some embodiments, the outer periphery of the first peripheral portion 151 is provided with an outer rib 161, and the inner wall 203 of the cavity 205 is also provided with an inner rib 116 that cooperates with the outer rib 161. The outer rib 161 is snapped onto the inner rib 116. Through the cooperation of the inner rib 116 and outer rib 161, the lid 101 can be connected to the housing 107, preventing the first peripheral portion 151 from contacting the inner wall 203 of the cavity 205 directly and causing deformation of the housing 107. In some embodiments, the outer rib 161 and the inner rib 116 are ultrasonically welded.

As additionally shown in FIG. 3A, in some embodiments, the outer circumference of the housing 107 is provided with an external thread 163. Below the external thread 163, there is provided an annular structure 165 arranged along the outer circumference of the housing 107. On the annular structure 165, an annular seal 167 is provided. The annular seal 167 is formed on the annular structure by injection molding.

The lower retainer 117 and micron filter 119 prevent filter media 115 from escaping the filter cartridge through the water outlet. The micron filter 119 is held in place by the lower retainer 117 which snaps into the housing 107.

Filter Media

The filter media is chosen based upon the requirements of the water purification quality. The filter media can be chosen from sorption media (e.g., activated carbon, synthetic zeolite, schungite, and the like); ion exchange media (e.g., ion exchange resins and the like), porous media (e.g., polypropylene, porous glass beads or frits, filter paper, and the like), catalytic media (e.g., KDF and the like), a disinfecting resin (e.g., iodine resin and the like) and mixed media combining properties of media of different compositions. Filter media can be selected and used to remove impurities such as bacteria, heavy metals, chlorine, organic impurities, inorganic impurities, radiological impurities, and the like. The filter media can be in the form of beads, powders, granules, formed between porous membranes or other forms. Examples of such filter media are described in U.S. Pat. Nos. 10,099,942; 8,252,185; 7,413,663; 7,276,161; 7,153,420; 6,752,768; and 5,635,063; all of which are incorporated herein by reference in their entirety. The filter media can be separated into individual layers or mixed together as a whole or with different combinations of filter media included as different layers. The filters of the invention can include more than one layer of a particular filter media or filter media mixture.

In some embodiments, the filter media 115 can be arranged like the water table retention in U.S. Pat. No. 10,099,942. In U.S. Pat. No. 10,099,942, the top down filter media 115 construction is a micron filter, a mixed bed ion exchange, a separator, and a redox alloy and carbon screen. In some embodiments, the filter media 115 can be arranged in layers or mixed. In some embodiments, the carbon screen layer is the last layer of filter media 115 that the filtered water passing through before water leaves the housing 107. In some embodiments, the carbon screen layer is the first layer of filter media 115 when the water enters the filter media 115.

As shown in FIG. 3A, the filter media 115 is contained by the filter cartridge 100. An activated carbon layer can be incorporated in the filter cartridge 100 as a beginning filter stage at or near the very beginning of the filtering process. While FIG. 3A shows an example of mixed filter media, the filter media can be separated into layers as well. For example, there can be an activated carbon layer, a redox alloy layer, a mixed bed ion layer, and other discrete layers of filter media. In one example of the invention, an activated carbon layer is designed and manufactured to remove organic elements from the unfiltered water. The activated carbon layer can be a powdered, granular, or carbon block material. The activated carbon filter medium may also simply be mixed into the rest of the filter media for varied water filtering results. However, it is preferable that the activated carbon filter medium be at or near the beginning of the filtering process. After the carbon layer of the filter media, any number of combinations, mixed or layered, of the filter media below may be used.

A redox alloy layer may also be incorporated in the filter cartridge 100. The redox alloy layer can be positioned immediately below the carbon layer, or it could be mixed into the carbon layer. The redox alloy layer is designed and manufactured to prevent the growth of mold, mildew, and bacteria in the water, in the filter cartridge, and in the filter materials. One example of the redox alloy layer includes a KDF (kinetic degradation fluxion) alloy, or other high purity alloys of copper and zinc. One example of the redox alloy layer includes flaked or granulated particulates.

A mixed bed ion exchange resin is also included in the filter cartridge 100. The mixed bed ion exchange resin is designed and manufactured to eliminate inorganic elements among other things. One example of the mixed bed ion resin includes porous beads or other porous structures with large surface area per volume characteristics. One example mixed bed ion resin in accordance with the invention includes approximately one-half anions and one-half cations. The mixed bed ion resin includes a highly developed structure of pores. On the surface of the pores, there are sites with easily trapped and released ions. The trapping of ions takes place with simultaneous releasing of other ions. That is the ion-exchange. Cations can be replaced with hydrogen ions, and anions can be replaced with hydroxyls. The hydrogen ions and the hydroxyls can recombine producing water molecules.

Additionally, dividers can be added between the filter layers to further eliminate inter-mixing of filter media and to further promote the even flow of water through the filter. An even flow of water through the filter prevents channeling within the filter media.

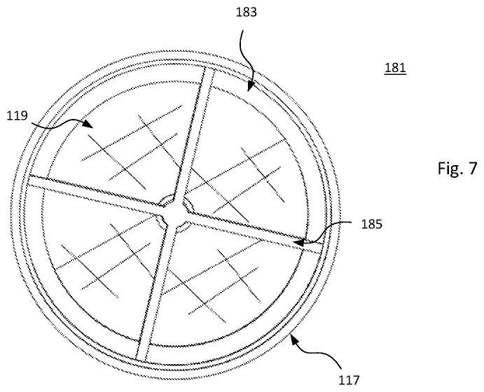

FIGS. 1, 2, and 5 show the housing 107 of the filter cartridge 100 in greater detail. The housing 107 sides include a narrowing from the top, water inlet, to the bottom, water outlet. The narrowing directs trapped air toward the top and water through the filter cartridge 100. FIG. 5 shows the outlet 121 at the bottom of the filter cartridge 100.

FIGS.1, 3A, and 4 show the lid 101 of the filter cartridge 100 in greater detail. The lid 101 includes at least a plurality planar portions that may be described as including a protruding portion 102 with a dome-like shape or truncated conical shape that extends from a lower planar portion 104 toward a topmost centered portion of the filter cartridge 100.

As shown in FIGS.9A and 9B, the lid 101 and spacer 113 are larger in diameter than the lower retainer 117 and micron filter 119 due to the side shape of the housing 107. In the example filter cartridge depicted in these FIGS., the lid and spacer 113 are positioned near the top/water inlet of the filter cartridge 100 and the lower retainer 117 and micron filter 119 are positioned near the bottom/water outlet 121 of the filter cartridge 100.

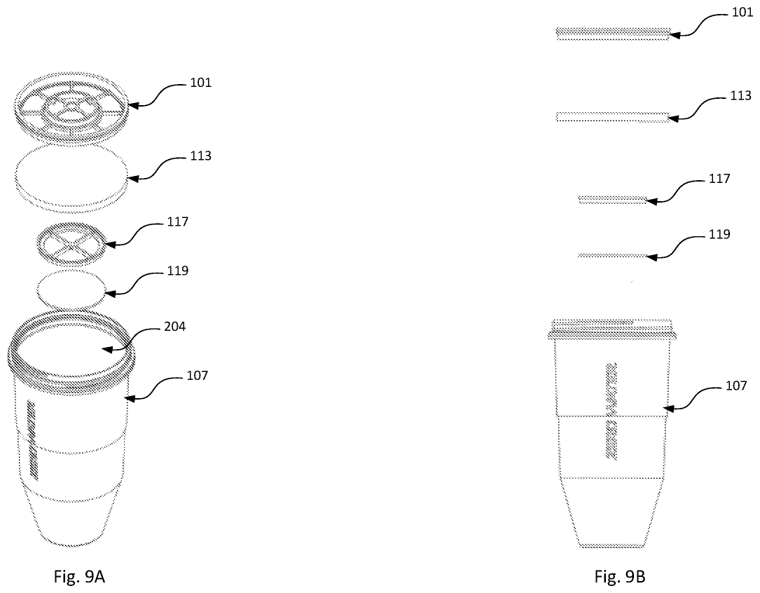

Referring to FIGS.6 and 7, in some embodiments, a supporting rib 171 is provided at the bottom of the cavity 205, the supporting rib 171 is located between the outlet 121 and the inner wall 203 of the cavity 205, and a second filter screen assembly 181 is provided on the supporting rib 171. The filter media 115 is filled in the cavity 205 between the second filter screen assembly 181 and the spacer 113. The supporting rib 171 can support the second filter screen assembly 181 and prevent the second filter screen assembly 181 from directly blocking the outlet 121. The supporting rib 171 is arranged between the outlet 121 and the inner wall 203 to prevent the supporting rib 171 from blocking the outlet 121. The second filter screen assembly 181 can prevent the filter media 115 from flowing out from the water outlet, and can filter the water flow. There may be multiple supporting ribs 171, which may extend from the inner wall 203 along the radial direction of the bottom of the cavity 205. The lengths of the multiple supporting ribs 171 may be the same or different. For example, two groups of supporting ribs 171 may be provided. The length of one group of supporting ribs 171 is greater than the length of the other group of supporting ribs 171, and the two groups of supporting ribs 171 are arranged adjacent to each other.

Referring to FIGS. 3A, 3B, and 7, in some embodiments, the second filter screen assembly 181 comprises a lower retainer 117 a micron filter 119. The micron filter 119 is ultrasonically welded to the bottom of the lower retainer 117, and the micron filter 119 is supported on the supporting rib 171. In some embodiments, the micron filter 119 is filter foam. The micron filter 119 can also be integrally formed on the second filter screen support 117 by injection molding.

As shown in FIGS. 3A and 3B, in some embodiments, the inner wall 203 of the cavity 205 is further provided with a buckling structure located above the supporting rib 171, and the buckling structure buckles the upper surface of the second filter support 117. In some embodiments, the buckling structure is a plurality of convex points 221 protruding from the inner wall 203 of the cavity 205. The buckling structure and the supporting rib 171 can completely fix the second filter screen assembly 181 in the vertical direction. In some embodiments, multiple convex points 221 are provided. For example, 10 convex points 221 are evenly provided along the circumferential direction of the inner wall 203 of the cavity 205. In some embodiments, as shown in FIG. 7, the lower retainer 117 includes a second peripheral portion 183, and the lower retainer 117 further includes a plurality of third connecting rods 185 arranged about the center of the second peripheral portion 183, and the third connecting rods 185 may provide support, and a water flow path directing filtered water through the second filter screen assembly 181. The water flow path of the second filter screen assembly 181 can be formed between the third connecting rods 185. As additionally shown in FIG. 7, two third connecting rods 185 are provided.

In some embodiments, the third connecting rods 185 extend radially from the second peripheral portion 183.

The micron filter 119 is a one-micron filter, such as a non-woven one-micron cloth, for example. The micron filter 119 is often positioned at the end of the filtration process. However, the micron filter 119 can also be placed at other positions (stages) in the filter cartridge 100, such as at the very beginning. The micron filter 119 is designed and manufactured for a dual purpose. The micron filter 119 eliminates the discharge of carbon dust or other filter media into the output (filtered) water and further filters out elements larger than one micron, such as cysts, contaminants, and other elements, for example. The micron filter 119 also provides an additional level of stability and containment of the filter media.

In some embodiments, the first filter screen 103 and the micron filter 119 are high temperature resistant nylon mesh. The first filter screen 103 and the micron filter 119 may be formed by injection molding. In some embodiments, the first filter screen 103, the micron filter 119, and the spacer 113 may all be made of non-woven materials. In some embodiments, the pore size of the first filter screen 103 or the micron filter 119 is between 200 and 270 microns. It can be understood that the apertures of the first filter screen 103 and the micron filter 119 are both smaller than the size of the filter media 115. In some embodiments, the distance between the protruding surface and the base is greater than or equal to 0.2 inches, ensuring that the water flow can break the balance between F1 and F2. In some embodiments, the diameter of the through-hole 105 is greater than or equal to 0.125 inches. As the air bubble formation conditions in different filter media 115 are different, the diameter of the through-hole 105 can be set according to the filter media 115. For example, the diameter of the through-hole 105 can be set to 0.3 inch.

The example embodiment of the claimed water filters prevents clogging of the filters due to air-locks that can otherwise occur in the filter when air is drawn in as the filter drains. The water filtration process and associated filtration cartridges of the invention eliminates the air locks and clogging by release of air trapped in the filter cartridge through the through-hole of the filter cartridge.

As shown in FIG. 10, in another embodiment of the invention, the lid 701 and annular seal 167 are integrated together. The annular seal 167 and lid 701 are welded to housing 707 which prevents separation of annular seal 167 from the filter cartridge and removal of the lid 701 from the housing 707.

In some embodiments, an adhesive sticker is attached to the outlet 121 to avoid air contact with the filter media 115.

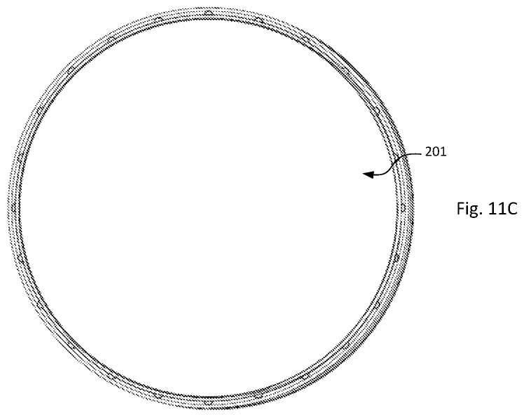

FIGS. 11A-C show the filter cartridge 100, in some embodiments, with an upper cover 201 with internal thread is provided for shipping or storage. The upper cover 201 can prevent the filter media 115 and water from evaporating, and can prevent the filter material from being polluted (such as by air). And in some embodiments, an unfiltered water container (not shown) with internal thread is provided. The external thread 163 on the housing 107 is matched with the internal thread of the upper cover 201 or the unfiltered water container. By injection molding the annular seal 167 on the annular structure 165, sealing can be provided when the upper cover 201 or the unfiltered water container is installed. And the annular seal 167 can be prevented from being lost.

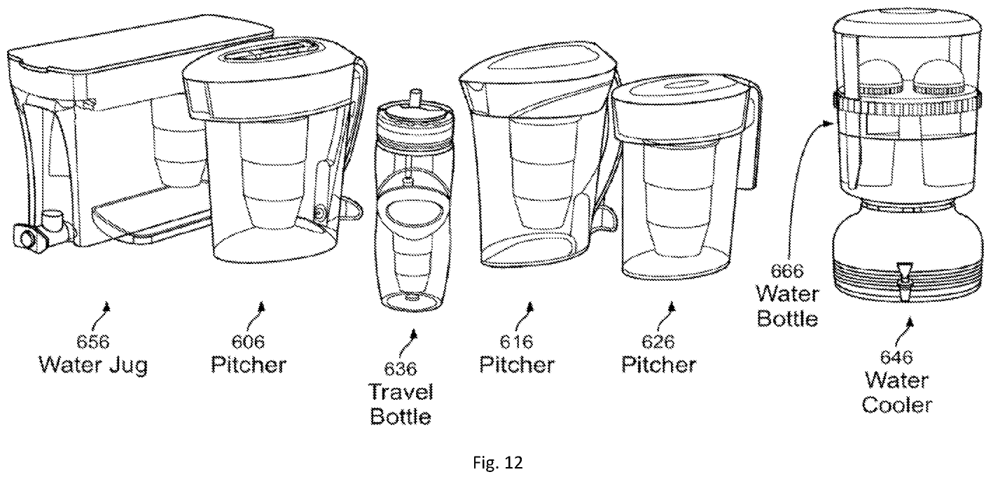

The water filters of the invention can be integrated into containers that house and store filtered water to form air lock eliminating water treatment apparatuses. These water containers can be in fluid communication with the water filter cartridge to receive and collect the filtered water from the water outlet on the filter. The filtered water can be stored in the water container for future use. As shown in FIG. 12, some example water containers that can be integrated with the water filters of the invention include pitchers 606, 616, 626, travel bottles 636, sports bottle, a water cooler 646, a water jug 656, and a water bottle 666.

The example embodiments of the claimed systems, devices, and methods of filtering liquids prevent clogging of filters due to air-locks, provide filter cartridges with improved performance, provide improved taste of the filtered water, and make the use of the filter systems easier for customers.

We claim:

1. A lid for a water filtration cartridge, comprising:
a plurality of planar levels, wherein one of the planar levels is proximate to the central axis of a housing of the filtration cartridge and proximate to a top of the lid,
wherein the lid is positioned at the water inlet of the housing;
a mesh section to allow ingress of water to the housing and prevent larger materials from entering the filter cartridge, and
a hole positioned proximate to the central axis of the housing and proximate to the top of the lid to allow air to escape from the housing,
wherein the hole opens to a cavity between the lid and a spacer adjacent to a bottom of the lid, and the spacer prevents a filter media of the filtration cartridge from exiting the housing and allows air to exit through the spacer.

2. The lid of claim 1, wherein the mesh section is on one of the planar levels.

3. The lid of claim 1, wherein the lid has a truncated cone shape.

4. The lid of claim 1, wherein the lid is separable from the housing.

5. The lid of claim 1, wherein the lid is welded to the housing.

6. The lid of claim 1, wherein the mesh section is supported by radial supports.

7. A water filter cartridge, comprising:
a housing with a water inlet and water outlet positioned along a central axis of the housing, the housing comprising:
a chamber that contains a filter media to filter water, and
a lid with a plurality of planar levels, wherein one of the planar levels is proximate to the central axis of the housing and proximate to a top of the lid,
wherein the lid is positioned at the water inlet of the housing, the lid including
a mesh section to allow ingress of water to the housing and prevent larger materials from entering the filter cartridge, and
a hole positioned proximate to the central axis of the housing and proximate to the top of the lid to allow air to escape from the housing,
wherein the hole opens to a cavity between the lid and a spacer adjacent to a bottom of the lid, and the spacer prevents the filter media from exiting the housing and allows air to exit through the spacer.

8. The filter cartridge of claim 7, wherein the lid has a truncated cone shape.

9. The filter cartridge of claim 7, further comprising:
a threaded portion for securing the filter cartridge in a water reservoir device.

10. The filter cartridge of claim 9, further comprising:
an O-ring integrated into the threaded portion.

11. The filter cartridge of claim 7, wherein the spacer is attached to the bottom of the lid.

12. The filter cartridge of claim 7, wherein the lid is separable from the housing.

13. The filter cartridge of claim 7, wherein the lid is welded to the housing.

14. The filter cartridge of claim 7, wherein the mesh section is supported by radial supports.

15. The filter cartridge of claim 7, wherein the filter media includes a plurality of layers of different materials.

16. The filter cartridge of claim 7, wherein the filter media include:
a carbon layer for removing at least one of chlorine or organic contaminants from the unfiltered water;
a redox alloy layer for neutralizing pH in the water;
an ion exchange layer for removing at least one of inorganic and radiological contaminants in the water; and
a micron filter layer.

17. The filter cartridge of claim 7, wherein the spacer is a food safe foam.

18. A water filtration device comprising:
a water reservoir; and
a filter cartridge comprising:
a housing with a water inlet and water outlet positioned along a central axis of the housing, the housing comprising:
a chamber that contains a filter media to filter water, and
a lid with a plurality of planar levels, wherein one of the planar levels is proximate to the central axis of the housing and proximate to a top of the lid,
wherein the lid is positioned at the water inlet of the housing, the lid including
a mesh section to allow ingress of water to the housing and prevent larger materials from entering the filter cartridge, and
a hole positioned proximate to the central axis of the housing and proximate to the top of the lid to allow air to escape from the housing,
wherein the hole opens to a cavity between the lid and a spacer adjacent to a bottom of the lid, and the spacer prevents the filter media from exiting the housing and allows air to exit through the spacer.

19. The water filtration device of claim 7, wherein the lid is separable from the housing.

20. The water filtration device of claim 7, wherein the lid is welded to the housing.
